(19) United States
(12) Patent Application Publication
(10) Pub. No.: US 2007/0180756 A1
(43) Pub. Date: Aug. 9, 2007

(54) Active artificial fishing lure and method of using same

(76) Inventor: Sean R. McHone, Cottage Grove, WI (US)

Correspondence Address: Sean R. McHone, 153 East Taylor Street, Cottage Grove, WI, 53527, US

(21) Appl. No.: 11/347,985

(22) Filed: Feb. 6, 2006

(51) Int. Cl. A01K 85/00; A01K 85/02

(52) U.S. Cl. 43/26.2; 43/35

(57) ABSTRACT

This invention is an active artificial game fishing lure that accurately replicates the appearance and movements of a live animal swimming on the surface of the water. Equipped with radio frequency remote control, the lure can be maneuvered around obstacles and into hard to reach locations. A plurality of spring-loaded hooks is hidden inside the body of the lure until the fish strikes. The bite-triggered hook mechanism then releases the hooks, firmly setting them into the fish's mouth. The lure can be designed to represent food sources for large freshwater game fish, such as a rodent (mouse, rat, chipmunk or muskrat), duckling, frog, salamander, or lizard. These features ensure that the angler will be able to get the lure into places where big game fish lurk, that the lure will stimulate the fish's natural feeding response, and that the fish will be hooked when it strikes the lure.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The invention relates generally to artificial fishing lures, and more particularly to active artificial fishing lures that are self-propelled.

Artificial fishing lures typically resemble or otherwise imitate live bait to be effective. Generally, lures are configured to resemble small avians, small amphibians, small crustaceans, insects, reptiles, rodents or small fish.

A drawback to artificial lures, however, is that they tend to exhibit unnatural movements, or movements that are otherwise not attractive to fish, when traveling through water because they are passive devices. That is, an angler simulates live prey movement by controlling the speed at which the lure is reeled back to the angler and by controlling the direction through slight jerking movements to the left or to the right.

To solve this drawback, some artificial lures have been made that more closely resemble movement of natural live bait. One example is provided by U.S. Pat. No. 6,910,294, which discloses a lure that contains a vibrating device within it to imitate the actions of live bait. The lure uses the vibrating device to impart movement that is difficult for the angler to sustain.

Another example is provided by U.S. Pat. No. 6,684,556, which discloses an artificial lure that mimics the movement of bait by utilizing an internal vibrating mechanism.

Another example is provided by U.S. Pat. No. 6,546,633, which discloses an artificial lure that more closely mimics the movement of bait that has a tail, such as a fish or crustacean. The lure possesses a specially designed tail segment with shoulders that impart a swimming action and a vibration to induce fish to strike.

Another example is provided by U.S. Pat. No. 6,536,155, which discloses an artificial lure that more closely resembles the movement of a rodent. The lure possesses a tail and four turbulence generators to simulate leg movement. Despite these advances, all of these devices are passive, in that they still require the angler to reel in the artificial lure.

Additionally, artificial lures must be placed with accuracy near fish to be effective. A common, and most popular, method to place a lure near fish is to cast the lure. A drawback to casting lures is that they tend to be misplaced or to get caught in nearby objects.

To solve this drawback, some lures have been made that allow the angler to get the lure near fish with greater accuracy. One example is provided by U.S. Pat. No. 6,760,995, which discloses a lure that has an electro-mechanically actuated dive plane and rudder for steering. The lure uses the actuated dive plane and rudder to get in the striking range of fish that are located at a depth in a body of water. Unfortunately, these lures are also passive in that each requires the angler to reel in the lure.

Furthermore, artificial lures must be able to avoid getting snagged on weeds or snagging objects in the water to be effective. A common method to avoid snagging a lure includes modifying the exposure of a hook. Drawbacks to modified hooks are that they do not always set correctly when a fish strikes the lure or that they result in difficulty in setting the hook or mis-setting of the hook.

U.S. Pat. No. 6,862,836 discloses an attempt to make a lure that has retractable, pivoting hooks. The lure uses the pivoting hooks to remain free of entanglements, yet deploy in sufficient time when triggered by a strike.

U.S. Pat. No. 6,813,857 discloses an attempt to make a lure that has a light-weight snag guard. The lure uses the snag guard to remain free of entanglements, yet be lightweight and adaptable to a variety of lure types.

U.S. Pat. Nos. 6,772,552 and 6,651,375 both disclose a lure that is snag-proof by virtue of a single hook hidden inside the body of the lure. The lure uses the snag-proof hook to remain free of entanglements, yet be effective in hooking.

For the foregoing reasons, there is a need for an artificial lure that resembles natural bait in its movement independent of the angler, that operates without snagging on objects and that is placed within the striking zone of fish.

### SUMMARY

The present invention is directed to an active artificial fishing lure that is guided by remote control. The lure is not reeled through the water by a fishing line like other lures.

In a first aspect, the present invention is a fishing system having an active artificial fishing lure and a radio frequency transmitter. The lure has a housing that resembles a prey of a fish. The lure has an eyelet that extends from the housing and allows for an end of a fishing line to be attached to the lure. The lure has a buoyancy means that keeps the lure afloat in a body of water. The buoyancy means are disposed within the housing of lure. The lure has a propulsion means for varying the direction of the lure in the body of water. The propulsion means are also disposed within the housing of the lure. The lure has a receiving means that receives a radio frequency signal from the radio frequency transmitter. The receiver means are also disposed within the housing of the lure and are connected to the propulsion means. The lure has at least one hook. Both the fishing lure and the radio frequency transmitter have a power source.

In some embodiments of the first aspect, the housing looks like a rodent, an amphibian, a reptile or an avian. In preferred embodiments of the first aspect, the housing looks like a mouse.

In some embodiments of the first aspect, the hook is a bite-triggered, spring-loaded hook that is disposed within the housing of the lure until a fish strikes the lure. In preferred embodiments of the first aspect, the bite-triggered, spring-loaded hook has a safety mechanism that prevents the hook from triggering when the lure is handled.

In a second aspect, the present invention is a fishing lure. The lure has a housing that resembles a prey of a fish. The lure has an eyelet that extends from the housing and allows for an end of a fishing line to be attached to the lure. The lure has a buoyancy means that keeps the lure afloat in a body of water. The buoyancy means are disposed within the housing of lure. The lure has at least one bite-triggered, spring-loaded hook that is disposed within the housing of the lure until a fish strikes the lure.

In some embodiments of the second aspect, the housing looks like a rodent, an amphibian, an avian or a reptile. In preferred embodiments of the second aspect, the housing looks like a mouse.

In some aspects of the second aspect, the bite-triggered, spring-loaded hook has a safety mechanism that prevents the hook from triggering when the lure is handled.

In some embodiments of the second aspect, the lure additionally has a propulsion means for varying the direction of the lure in the body of water. The propulsion means are also disposed within the housing of the lure. The lure further has a power source disposed within the housing and connected to the propulsion means.

In a third aspect, the present invention is a method of fishing with an active artificial fishing lure. The method has a first step of providing an active artificial fishing lure. The method has a second step of providing a radio frequency transmitter. The radio frequency transmitter controls directional movement of the fishing lure. The method has a third step of securing an end of a fishing line to the fishing lure. The method has a fourth step of placing the fishing lure into a body of water. The method has a fifth step of guiding the fishing lure to a desired location with the radio frequency transmitter. The method has a fifth step of retrieving the fishing lure.

In some embodiments of the third aspect, the fishing lure has at least one bite-sensitive, spring loaded hook.

### BRIEF DESCRIPTION OF THE DRAWINGS

The invention will be better understood and features, aspects and advantages other than those set forth above will become apparent when consideration is given to the following detailed description thereof Such detailed description makes reference to the following drawings, wherein:

FIG. 1 shows the exterior of the lure in an isometric perspective viewed from the upper left of the lure.

FIG. 2 shows the exterior of the lure in an isometric perspective viewed from the lower right.

FIG. 3 shows the exterior of the lure with the hooks in the triggered position in an isometric perspective viewed from the upper left.

FIG. 4 shows the lure with the trigger (hinged upper forward body component) removed. The hooks are in the retracted (loaded) position. The image is an isometric perspective representation viewed form the upper left.

FIG. 5 shows the lure with the trigger (hinged upper forward body component) removed. The hooks are in the extended (triggered) position. The image is an isometric perspective representation viewed form the upper left.

FIG. 6 shows the underside of the trigger. The image is a perspective representation viewed from the real left side.

FIG. 7 shows the spring loaded hook assembly and trigger latch. The hooks are in the retracted (loaded) position. The image is a perspective representation viewed from the left side slightly above center.

FIG. 8 shows the spring loaded hook assembly and trigger latch. The hooks are in the extended (triggered) position. The image is a perspective representation viewed from the left side slightly above center.

FIG. 9 shows the inside of the lower body component of the lure with the leg actuating mechanism visible. The image is a perspective representation viewed from above and slightly to the front and left of the lure.

FIG. 10 shows the legs and leg actuating mechanism of the lure. The image is a perspective representation viewed from the upper left of the lure orientation.

FIG. 11 shows the legs and leg actuating mechanism in motion. Arrows next to the near side components indicate the direction of motion for each component in the mechanism. The image is a perspective representation viewed from the upper left of the lure orientation.

FIG. 12 is a detail view of the lures leg assembly in the extended position. This view is a perspective representation viewed form the front and left of the leg.

FIG. 13 is a detail view of the lures leg assembly in the bent knee position. This view is a perspective representation viewed form the left and slightly forward.

FIG. 14 is a detail view of an alternate single piece leg design. This view is a perspective representation viewed form the left and slightly back.

FIG. 15 shows all of the electrical and electronic components as mounted in the lower body of the lure. The components obscured by the lower body are represented using lighter lines. The image is an isometric perspective representation viewed form the upper left.

FIG. 16 shows all of the electrical and electronic components in an as mounted orientation without the lower body represented. The portions of components obscured by other components are represented using lighter lines. The image is an isometric perspective representation viewed form the upper left.

FIG. 17 shows the top of a suitable remote control transmitter assembly. The image is an isometric perspective representation viewed form the upper left.

FIG. 18 shows the bottom of a suitable remote control transmitter assembly. The image is an isometric perspective representation viewed form the upper left.

While the invention is susceptible to various modifications and alternative forms, specific embodiments thereof have been shown by way of example in the drawings and are herein described below in detail. It should be understood, however, that the description of specific embodiments is not intended to limit the invention to cover all modification, equivalents and alternatives falling within the spirit and scope of the invention as defined by the appended claims.

### DETAILED DESCRIPTION

Unlike any other artificial fishing lure, the present invention propels itself on the surface of a body of water.

For ease of understanding, the components of the lure can be categorized into the various subsystems required to make the invention perform as intended. These subsystem categories are as follows: (1) exterior/structural elements, (2) buoyancy system, (3) hook mechanism, (4) propulsion mechanism, and (5) electronics/controls system.

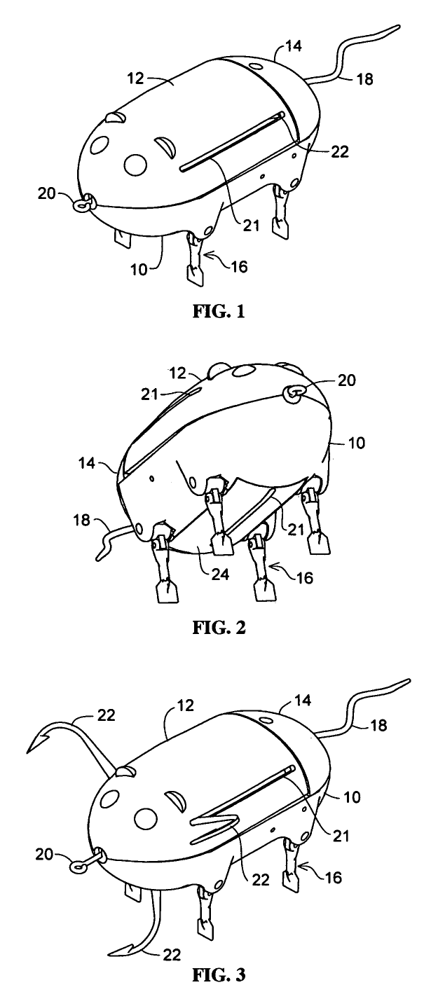

Exterior/Structural Elements: The exterior/structural elements of the lure include a chassis (10), a trigger (12), a rear cover (14) and a battery cover (24). The outer surfaces of these components (10, 12, 14, 24) are in the general shape of an animal of prey to a game fish such as a duckling, frog, lizard, or rodent. The rodent (mouse) form of the lure is illustrated in FIG. 1, FIG. 2 and FIG. 3. These components (10, 12, 14, 24) must be tough, lightweight and durable enough to withstand the force of multiple fish strikes and the jarring forces of the fish thrashing about, as it is being landed by the angler. Components (10, 12, 14, 24) are preferably formed through injection molding of a rugged and dimensionally stable polymer such as ABS, high or ultra-high molecular weight polyethylene, or polyamide 66 (nylon), although other polymers or polymer combinations are suitable.

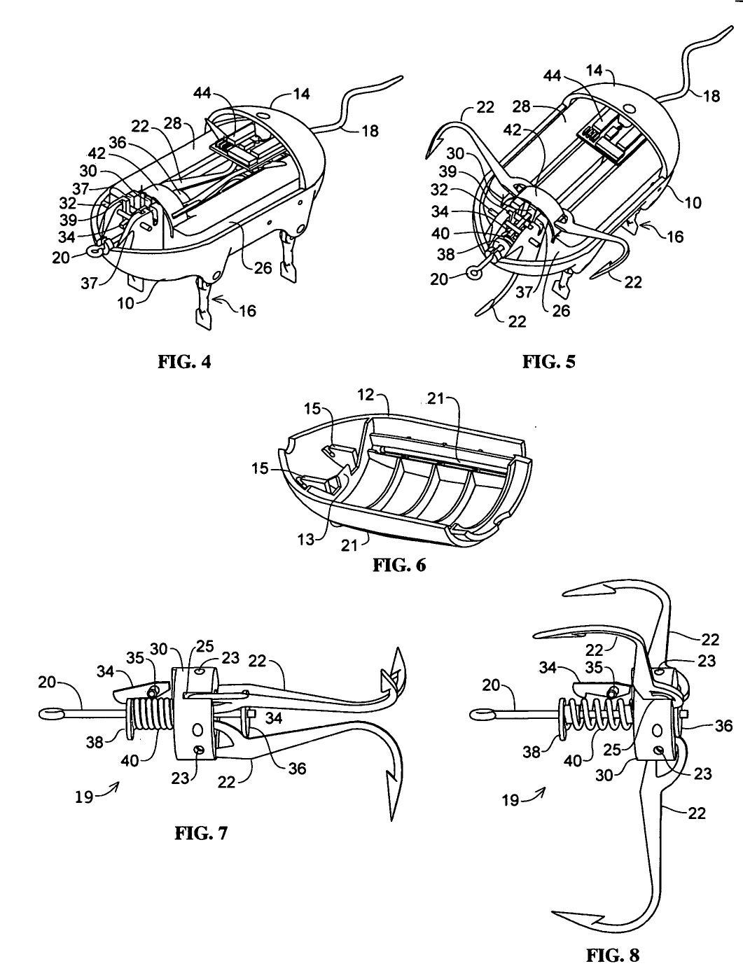

The chassis (10) is the structural foundation that all other elements are attached to either directly or indirectly. The chassis (10) forms the lower half of the exterior body of the lure. The depicted design for the chassis (10) is of a one-piece construction to maximize strength and to minimize part requirements. Alternatively, the chassis (10) is constructed in two halves that are preferably attached together by means of screws or adhesive, thereby improving ease of assembly. Construction and placement of various internal features of the chassis (10) are illustrated in FIGS. 4, 5, 8 and 14. A description and purpose of each internal feature of the chassis (10) is explained below within the context of each subsystem that is attached directly or indirectly to the chassis (10).

As shown in FIGS. 1, 2, 3, and 6, the trigger (12) forms the upper half and forward two-thirds of the lure exterior. The trigger (12) connects to the chassis (10) via slotted tabs (15) that snap onto a trigger hinge pin (32). The trigger (12) may rotate slightly about the trigger hinge pin (32). A small torsion spring (not shown) is located on the central portion of the trigger hinge pin (32). The small torsion spring terminates on one end in contact with the trigger (12) and on the other end in contact with the trigger latch (34). The small torsion spring holds the trigger (12) up and the trigger latch (34) down.

The rear cover (14) forms the upper half and rear third of the lure exterior. The rear cover (14) is preferably attached to the chassis by means of a screw or adhesive. The rear cover (14) helps keep the trigger (12) in place and protects a radio frequency receiver (44) hidden within.

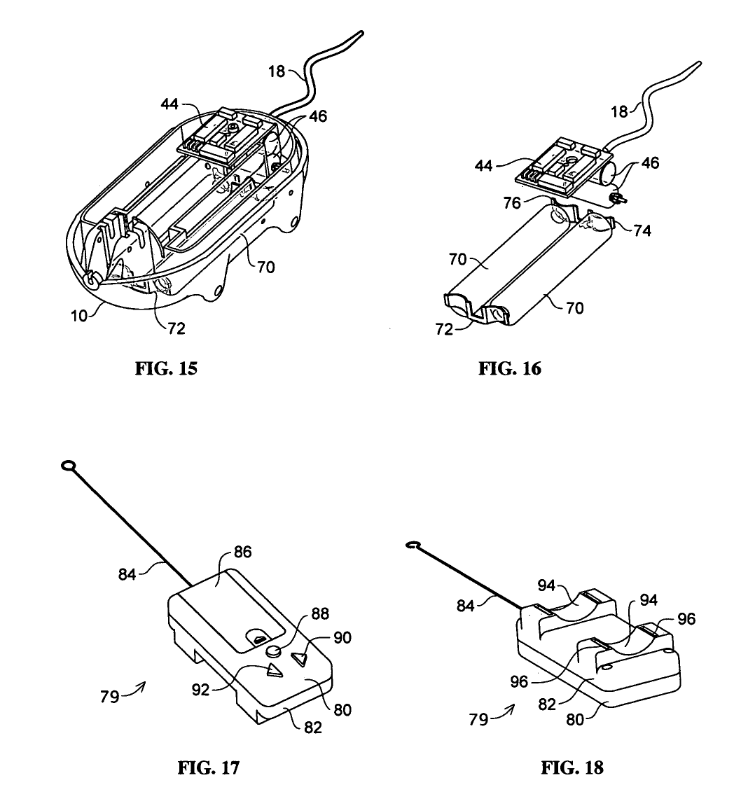

The battery cover (24) is provided to allow for access to batteries (70, see FIG. 14 and FIG. 15), which are mounted inside a bottom of the lure.

A tail (18) is also a radio frequency receiving antenna. The tail (18) is constructed of a piece of wire covered with a rubbery polymer or latex to simulate the appearance of a tail. In use, a tip of the tail (18) is curled up out of the water to ensure proper reception of radio signals from the transmitter (79). Alternate forms of the lure such as a duckling or a frog would not have a tail (18). An antenna for these alternate forms would be mounted internally, just below the trigger (12) and/or the rear cover (14).

Legs (16) protrude from a bottom of the chassis (10). The legs (16) oscillate to provide the forward thrust that makes the lure swim. The legs (16) are discussed in detail below within the propulsion mechanism section of this description.

Buoyancy System: The lure is intended to remain on the surface of a body of water when in use. This is so that it aptly resembles a prey animal swimming on the water and so that the antenna remains above the water's surface. In order for the lure to remain on the surface of the water, the portion of the lure below the surface must displace a volume of water equal in weight to the entire lure assembly. Therefore, a buoyancy cavity (26) is incorporated into the construction of the lure. The buoyancy cavity (26) is open at the bottom of the lure for the legs (16) to extend therefrom. The buoyancy cavity's (26) upper perimeter extends to slightly above the horizontal center of the lure. A buoyancy cover (28), manufactured from the same material as that chosen for the chassis (10), is attached to the top of the buoyancy cavity (26) with a snap fit and/or waterproof adhesive such as silicone calk. This connection must be airtight so that air is trapped within the buoyancy cavity (28) when the lure is place in the water. All other holes leading into the buoyancy cavity (26), except those located at or below the legs pins (66), must also be sealed with a waterproof adhesive such as silicone calk. This construction ensures that, when the lure is set upright into the water, a bubble of air is trapped in the buoyancy cavity (28). The air bubble will displace water without adding weight to the lure. The air bubble also serves as the environment in which the components of the propulsion mechanism reside. If gears operate in direct contact with water, much of the energy developed by the motors is lost as the gears continually pump water out for the gear teeth to mesh.

Hook Mechanism: The lure incorporates a bite-triggered, spring-loaded hook mechanism (19). The spring loaded hook mechanism (19) is desirable because fishing line remains slack while fishing in the method determined by the invention. If the lure was equipped with conventional hooks, the angler would have to tighten up the line to set the hooks. Consequently, the angler would catch fewer fish.

Because a plurality of hooks (22) are retracted within the body of the lure until a fish strikes the lure, the bite-triggered spring loaded hook mechanism (19) also ensures that the lure does not get snagged on weeds or branches in the water.

The spring-loaded hook mechanism (19) is illustrated in FIG. 4 and FIG. 5 as installed in the chassis (10) in a retracted position (loaded—FIG. 4) and an extended position (triggered—FIG. 5). FIG. 7 and FIG. 8 show the spring-loaded hook mechanism (19) free of the lure, also in the retracted position (loaded—FIG. 7) and the extended position (triggered—FIG. 8).

A plurality of hooks (22), are mounted by pins (23), preferably constructed of stainless steel, into a hook flange (30) containing a plurality of slots (25). The hook flange (30) is preferable formed by injection molding or machining a rugged and dimensionally stable polymer such as ABS, high or ultra-high molecular weight polyethylene, or polyamide 66 (nylon) or a lightweight metal such as aluminum. The slots (25) are oriented at 120 degrees intervals about the central axis of the hook flange (30). The hook flange (30) is attached to the chassis (10) via a snap fit connection. A sliding shaft (20) runs through the center of the hook flange (30). The sliding shaft (20) is preferably manufactured from spring tempered stainless steel wire. One end of the sliding shaft (20) is terminated in a loop or an eye, thereby providing a place or point to attach the fishing line or a fishing leader. A retaining collar (38), preferably constructed of stainless steel, is attached via silver solder, mechanical compression or interference fit near the loop or eye of the sliding shaft (20). A compression spring (40), preferably wound from stainless steel, is placed between a retaining collar (38) and the hook flange (30). A plunger (36), preferably constructed from stainless steel and shaped like a disk, is attached via silver solder, mechanical compression or interference fit at the other end of the sliding shaft (20). Alternatively, the spring-loaded hook mechanism (19) could use one or two hooks (22). Alternatively, screws could be used to attach the hook flange (30) to the chassis (10).

Force on the sliding shaft (20) compresses the spring (40) between the retaining collar (38) and the hook flange (30). When the compression spring (40) is compressed sufficiently, the front of a trigger latch (34) drops down in front of the retaining collar (38). An end of the trigger latch (34) is lobed to catch on a front side of the retaining collar (38). The trigger latch (34) is mounted at a center of a stainless steel pivot pin (35) via silver solder, mechanical compression or interference fit. The pivot pin (35) fits into slots (37) in the front portion of the chassis (10). The small torsion spring (not shown, but mentioned above) is looped around the trigger hinge pin (32) keeps the trigger (12) forced up and the trigger latch (34) forced down in front of the retaining collar (38). A small torsion spring (not shown) located at each hook mounting position fold the hooks (22) into the lure body through the hook slots (21) as the sliding shaft (20) is forced into the chassis (10).

When force is applied to the trigger (12) presumably from a biting fish, the trigger (12) rotates down about the trigger hinge pin (32). A protrusion (13) pointing down from the under side of the trigger (12) pushes down on a rearward side of the trigger latch (34), thereby lifting the lobed end of the trigger latch (34). When the lobed end of the trigger latch (34) is lifted sufficiently, the retaining collar (38) slips past. The sliding shaft (20) then rapidly extends forward under the force of the compression spring (40). As the sliding shaft (20) moves forward, the plunger (36) forces the hooks (22) to rapidly rotate about their mounting pins (23), which snap the hooks (22) out of the hook slots (21) and into flesh of the fish's mouth. Full extension of the compression spring (40) causes the plunger (36) to seat against the hook flange (30). In this position, the hooks (22) are fully extended and are locked against the outside of the plunger (36).

If the hooks (22) do not fully extend after a fish strike has activated the hook mechanism (19), the act of reeling in the fish will apply additional force to the sliding shaft (20) and plunger (36) to cause full extension and setting of the hook or hooks (22) into the fish's mouth. Only a force pressing directly in on the eye of the sliding shaft (20) will allow the plunger (36) to disengage from the hooks (22) after they have been fully extended.

To remove the lure from the fish's mouth, the hook mechanism should be set to a safety position by pressing the shaft (20) completely back into the lure and turning the shaft eye 90 degrees or to a vertical orientation. In this position, a lower lobed area of the retaining collar (38) is rotated into a slot [needs a number] in the chassis (10). In this safety position, force on the trigger (12) will not cause the retaining collar (38) to be released. Any hooks that are not stuck into the flesh of the fish's mouth will retract into the lure body when the shaft (20) is pushed back into the chassis (10). Once each remaining hook (22) is freed from the fish, they will also retract into the lure body, allowing the lure to be removed.

To set the spring-loaded hook mechanism (19) back to the safety position, one presses in on the sliding shaft (20) turn the eye back to the horizontal position and slowly allows the sliding shaft (20) to slide out of the chassis (10) until the retaining collar (38) is in contact with and caught by the lobe in the trigger latch (34).

This spring-loaded hook mechanism (19) could alternatively be used in conventional non-remote controlled and non-motorized lures. In applications where the lure needs to be cast during use, the trigger mechanism is fitted with a water-activated electromechanical safety relay, such as those used in flood or standing water alarm systems, to prevent the hooks from being triggered when the lure hits the water. Such a safety relay would be inactive when the lure is out of water. In the inactive position, armature of a small electric coil driven linear actuator is extended to prevent the trigger latch (34) from moving. Probes and a small CPU and battery mounted inside the lure detect resistance when the lure is submerged in water. At that point, a linear actuator is charged, pulling the armature out of the trigger latches' path of movement. With the trigger latch now free to move the hook mechanism would be triggered when struck by a fish. When the lure is pulled out of the water to be recast, the CPU would detect the change in resistance between the probes and disengage the hook mechanism.

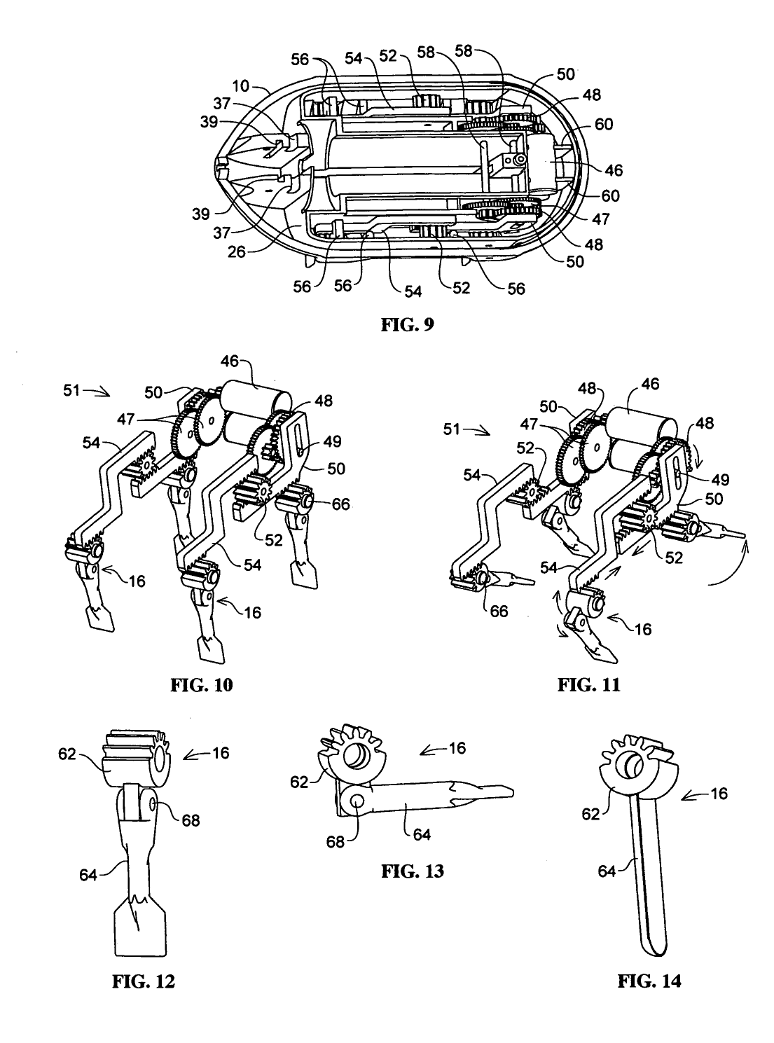

Propulsion Mechanism: Unlike any other lure this lure is designed to actively swim across the surface of the water in any direction as a real prey animal would. To achieve this end, an electromechanical propulsion mechanism (51) was devised. The propulsion mechanism (51) is illustrated in FIGS. 9, 10 and 11. The propulsion mechanism (51) movement is illustrated using arrows in FIG. 11. The leg (16) is illustrated in FIG. 12 and FIG. 13. An alternate design for the leg (16) is illustrated in FIG. 14.

Motion of the legs (16) is initiated using two miniature DC electric motors (46). The high-speed, low-torque rotary motion of each motor (46) is transmitted through a series of gears (47, 48) mounted on shafts (58), preferably constructed from stainless steel. The gears (47, 48) lower the RPM and increase the torque developed by the motor (46). The final gear (48) has an eccentric pin (49) protruding from its outside surface. The eccentric pin (49) converts rotary motion of the final gear (48) to reciprocating motion in the primary rack slide (50). The primary rack slides (50) have a gear rack portion on front and rear ends that engage a standard pinion (52) and the shoulder pinion (62) of the rear legs (16), respectively. Secondary rack slides (54) have a gear rack portion on rear and front ends that engage the standard pinion (52) and the shoulder pinion (62) of the front legs (16), respectively. The gear tooth engagement between the rack slides (50, 54) changes a reciprocating motion of the rack slides (50 and 54) into oscillating rotary motion in the legs (16). Since the primary rack slide (50) engages the standard pinion (52) on the bottom, and the secondary rack slide (54) engages the standard pinion (52) on the top, the rack slides (50, 54) move in opposite directions. This arrangement causes the front and rear legs (16) to always rotate in opposite directions. The direction in which the rack slides (50, 54) are moving and in turn, the direction in which the legs (16) are rotating is reversed every half revolution of the final gear (48).

As shown in FIG. 12 and FIG. 13, the leg (16) is comprised of a shoulder pinion (62) and a lower paddle (64) connected together by a hinge pin (68), preferably constructed of stainless steel. The paddle (64) can freely rotate about the hinge pin (68) from the fully extended position, shown in FIG. 12, to the 90 degree bent position, as shown in FIG. 13. A leg actuating mechanism causes the legs (16) of the lure to paddle in such a way as to propel it through the water. The legs (16) therefore move in a similar fashion to any four-legged animal attempting to swim. When the legs (16) rotate forward (clockwise as depicted) the paddle (64) folds under to create the least amount of drag force between the leg (16) and the water. When the legs (16) switch direction and rotate backward (counter-clockwise as depicted), the paddles (64) extend out and lock at the hinge pin (68) to create the maximum amount of drag force between the leg (16) and the water. The paddle (64) switches from extended to bent positions due to the drag forces encountered through its interactions with the body of water as the leg (16) rotates forward or back. Since the drag force on the legs (16) when moving back through the water is greater than the drag force on the legs (16) when returning to the forward position, the net force will cause the lure to be propelled forward through the water. The lure will in fact be swimming.

All gears (48, 52), rack slides (50, 54), and legs (16) would preferably be formed through injection molding of a polymer such as polypropylene or polyamide 66 (nylon). These polymers are a bit more flexible and run quieter that ABS.

As shown in FIG. 8, several guides (56) are incorporated within the buoyancy cavity (28) of the chassis (10) and also on the underside of the buoyancy cavity (28). The guides (56) keep the rack slides (50, 54) properly aligned and engaged with the pinion gears (52) and the shoulder pinions (62). The motors (46) snap fit into the chassis (10) via slotted and undercut uprights (60) that are incorporated within the buoyancy cavity (28) of the chassis (10). The legs (16) are attached to the chassis (10) using a shoulder pin (66), which is preferably constructed of the same material as the chassis (10). When the legs (16) are slipped into the chassis (10), the shoulder pins (66) are inserted through apertures in the lower portion of the chassis (10) and pressed or snap fit into the shoulder pinions (62). The holes in the chassis (10) must be slightly larger than the shoulder pin (66) to allow the legs (16) to rotate freely (if not for the gear tooth engagement of the rack slides (50, 54). The use of a larger polymer shoulder pin (66) allows for the legs (16) to be easily removed and replaced if they become damaged.

An alternate embodiment of the leg (16) is illustrated in FIG. 14. The leg (16) is of a single piece design and is a direct replacement to the design illustrated in FIG. 12 and FIG. 13. The paddle portion (64) is a thin curved shape, like the shape of a retractable steel tape measure. The paddle portion (64) terminates in a semi-circular scoop. A curved strip of polymer, such as depicted, exerts a force while moving in one direction and folds under while moving in an opposite direction. An example of this property, and where it can be observed, is a steel tape measure. Several feet of tape can be extended and held horizontally when the curl of the tape flares up. When the tape is flipped over, however, it folds down immediately. A single piece leg (16, FIG. 14) simplifies the assembly process and reduces the cost of the lure. This leg (16, FIG. 14) is produced by injection molding and is made of polypropylene or like material. Polypropylene is ideal because of its flexibility and its ability to withstand many cycles of bending without cracking and breaking.

Electronics and Controls System: The electronics and controls system is illustrated in FIG. 15, 16, 17 and 18. The electronics and controls system includes batteries (70), battery contacts (72, 74, 76), a radio frequency receiver (44), the antenna/tail (18) and a remote radio frequency transmitter (79). Propulsion mechanisms motors (46) are powered by two standard AAAA size batteries (70), which reside inside the bottom of the chassis (10). The batteries (70) are accessed for replacement or recharging through the battery access cover (24, FIG. 2). The batteries (70) are located at the bottom of the lure because in this position their weight will ensure the lure remains upright in the water. Alternatively, smaller batteries such as those used in car alarm systems may be used. FIG. 15 shows the batteries (70) drawn in light lines as installed in the chassis (10). FIG. 16 shows the batteries (70) unobscured by the chassis (10). The battery contact (72) provides a connection between a positive end of one battery (70) and a negative end of another battery (70). In this scenario, three volts of potential is present between the positive and negative ends of the batteries (70) at the rear of the lure. A positive battery contact (76) and a negative battery contact (74) mounted in the rear end of the lure battery cavity delivers current via twenty-four to thirty gage wires (not shown) to the radio frequency receiver (44). The radio frequency receiver (44), upon receiving an appropriate signal from the transmitter (84), sends current to one of or both of the motors (46), thereby causing motion in the legs (16) in the manner described in the propulsion mechanism portion of the invention. The battery contacts (72, 74, 76) are preferably made of stainless steel or nickel plated carbon steel and are attached to the inside of the chassis (10) via a snap fit or waterproof adhesive.

The remote radio frequency transmitter (79), shown in FIG. 17 and FIG. 18, depicts one suitable control unit for this application. The transmitter's exterior shell components (80, 82, 86) are preferably constructed of injection molded ABS plastic. A transmitter antenna (84) is manufactured of a corrosion resistant, yet stiff electrically conductive wire such as stainless steel spring tempered music wire. A transmission range of the transmitter is determined by a power output and a length of the transmitting (84) and receiving (44) antennas. A usable transmission range of zero to at least one hundred feet is required in this application. The transmitter (79) is ideally attached to the angler's fishing pole while in use. This is achieved through the construction of a back half (82) of the unit. Two semi-cylindrical surfaces (94) are located on the back half (82), which keep the transmitter (79) centered on the fishing pole. Two slots (96) on either side of the semi-cylindrical surfaces (94) are provided through which a strap of Velcro® (or other suitable hook and loop material) or elastic can be passed. The strap tightly affixes the transmitter (85) around the fishing pole. For the convenience of the user, it is also desirable to incorporate a battery access cover (86) on the transmitter's front surface (80). This enables the angler to change the transmitter's batteries without removing the transmitter (79) from the fishing pole. For most anglers, the fishing pole is normally held in one hand while the dominant reels in the fish or holds a beverage. The attachment of the transmitter (79) on top of the fishing pole also allows the to angler press the buttons (88, 90, 92) that control the lure with a thumb of a hand he/she holds the pole with, thereby keeping the reeling/beverage hand free.

In a typical embodiment, the transmitter (79) has a start/stop button (88), pushed by the angler to start and stop both motors (46) i.e. start swimming or stop swimming. After the lure is placed upright in the water, the angler pushes the start/stop button (88) to start the lure swimming. The angler then uses a right button (90) and a left button (92) to change the direction in which the lure swims. When the right button (90) is held down, a signal is sent from the transmitter (84) to the receiver, interrupting the current flow to the motor (46) powering the right side legs (16). Stopping the right side legs (16) causes more drag on the right side thereby causing the lure to start turning to the right. The longer the button is held the more right the lure will turn. When the right button (90) is released, the motor (46) on the right side again receives current and the lure takes off straight in whatever direction it happens to be pointing. Likewise, when the left button (92) is pressed, the lure turns left.

Alternatively, an additional feature that can be added to the transmitter (79) and receiver (44) combination is a fine adjustment to the amount of power that one or both of the motors (46) are receiving. This would enable the angler to remotely control the speed and more easily control the turning radius of the lure.

Alternative Embodiments: Alternative embodiments (not depicted) include a two-legged versions with a wider paddle portion to simulate the appearance and swimming motion of a duckling. In the duckling model, the pinions (52) and secondary rack slides (54) are eliminated. The exterior appearance of the trigger (12) and chassis (10) is modified to resemble a duckling in form. A frog embodiment is a four-legged version in which the rear legs (16) are much longer, flair out to the sides of the lure, and has a larger flipper at the end of the paddle portion (64). Only a few modifications are made to the exterior appearance of the trigger (12) and the chassis (10) to adequately mimic the appearance of the frog. In both of these alternative embodiments, the tail/external antenna (18) is eliminated and replaced with an internal antenna wire. A salamander and a lizard embodiment would be longer and thinner than the mouse. The tail (18) of these embodiments is also thicker and more pronounced.

To more accurately mimic the appearance of the prey species embodiments mentioned, external body coverings are applied with waterproof adhesive. The application of synthetic or natural fur to the exterior of the rodent embodiment, synthetic or natural down feathers to the exterior of the duckling embodiment, or a synthetic rubbery polymer or latex skin to the exterior of the lizard and salamander embodiment are preferred finishing treatments. The application of waterproof paint or using color died polymers and appropriately textured molds when injection molding the external body components makes the external appearance of the lure more realistic and lifelike in any of the aforementioned embodiments.

I claim:

1. A fishing system comprising:
an active artificial fishing lure, wherein the fishing lure comprises:
a. a housing designed to resemble a prey for a fish;
b. an eyelet extending from the housing, wherein the eyelet attaches to an end of a fishing line;
c. a bouyancy means for keeping the lure afloat in a body of water, wherein the buoyancy means are disposed within the housing;
d. a propulsion means for varying the direction of the lure in the body of water, wherein the propulsion means are disposed within the housing;
e. a receiver means for receiving a radio frequency signal, wherein the receiver means are disposed within the housing, and wherein the receiver means are connected to the propulsion means;
f. a power source disposed within the housing and connected to the propulsion means and the receiving means;
g. at least one hook; and
a transmitting means for controlling the direction of propulsion of the lure, wherein the transmitting means emits the radio frequency signal to the receiver means, and wherein the transmitting means has a power source.

2. A fishing system as recited in claim 1, wherein the housing resembles a rodent, an amphibian, an avian or a reptile.

3. A fishing system as recited in claim 1, wherein the housing resembles a mouse.

4. A fishing system as recited in claim 1, wherein the hook is a bite-triggered, spring-loaded hook, and wherein the hook is disposed within the housing until a strike;

5. A fishing system as recited in claim 4, wherein the bite-triggered, spring-loaded hook has a safety mechanism that prevents the hook from triggering when the lure is handled.

6. A fishing lure comprising:
a housing designed to resemble a prey for a fish;
an eyelet extending from the housing, wherein the eyelet attaches to an end of a fishing line;
a bouyancy means for keeping the lure afloat in a body of water, wherein the buoyancy means are disposed within the housing; and
at least one bite-triggered, spring-loaded hook, wherein the hook is disposed within the housing until a strike.

7. A fishing lure as recited in claim 6, wherein the housing resembles a rodent, an amphibian, an avian or a reptile.

8. A fishing lure as recited in claim 6, wherein the housing resembles a mouse.

9. A fishing lure as recited in claim 6, wherein the bite-triggered, spring-loaded hook has a safety mechanism that prevents the hooks from triggering when the lure strikes the water after being cast.

10. A fishing lure as recited in claim 6 further comprising a propulsion means for propelling the lure as to accurately resemble a prey for a fish swimming on the surface of a body of water, wherein the propulsion means are disposed within the housing; and
a power source disposed within the housing and connected to -the propulsion means.

11. A method of fishing with an active artificial fishing lure, comprising:
providing an active artificial fishing lure;
providing a radio frequency transmitter, wherein the transmitter controls directional movement of the remote-controlled fishing lure;
securing an end of a fishing line to the remote-controlled lure;
placing the active artificial fishing lure into a body of water;
guiding the lure to a desired location with the radio frequency transmitter; and
retrieving the lure.

12. A method of fishing as recited in claim 11, wherein the fishing lure further comprises at least one bite-sensitive, spring loaded hook.
